(19) United States
(12) Patent Application Publication
(10) Pub. No.: US 2003/0034293 A1
(43) Pub. Date: Feb. 20, 2003

(54) Method of treating filtration media to prevent lateral flow, blistering and de-lamination

(75) Inventor: John A. Simonetti, Thousand Oaks, CA (US)

Correspondence Address: Mr. Charanjit Brahma, PILLSBURY WINTHROP LLP, Suite 2800, 725 South Figueroa Street, Los Angeles, CA, 90017, US

(73) Assignee: PTI Advanced Filtration, Inc.

(21) Appl. No.: 09/931,360

(22) Filed: Aug. 16, 2001

(51) Int. Cl. B01D 63/10

(52) U.S. Cl. 210/321.74; 210/321.83; 210/483; 210/488; 210/490

(57) ABSTRACT

The present invention is directed to a filter element in which an undesired fluid flow path through the filter element is blocked. The present invention is also directed to a method for producing such a filter element. In embodiments of the invention, the filter element may be a spiral wound filter element with a filter membrane. The desired flow path through the filter membrane may be through the lateral surface of the filter membrane, while an undesirable flow path may begin at a point on the cross-sectional face of the filter membrane. To prevent fluid from entering the filter membrane through the cross-sectional face, the pores of the filter membrane near the cross-sectional area may be sealed, for example, by filling the pores with a substance, such as a polymer.

### BACKGROUND

Cross-flow filtration or separation systems generally involve the separation of an unfiltered feed fluid into a concentrated feed fluid and a permeate fluid. The unfiltered feed fluid may flow substantially parallel to the surface of a filter element. As the unfiltered feed fluid passes across the surface of the filter element, the permeate fluid will pass through the filter element and the remaining concentrated feed fluid may continue to flow in the same direction as the unfiltered feed fluid. Cross-flow filtration systems are often preferable because, unlike dead-end filtration processes in which the flow of unfiltered fluid is perpendicular to the surface of the filter element, the filter element is not subject to fouling by removed contaminants (i.e., “caking” of the removed contaminant on the filter element surface). As a result, cross-flow filter elements generally have a longer service life than dead-end filters. Moreover, while in service, cross-flow filtration systems generally exhibit more consistent filtration or separation capabilities.

Such systems are commonly used in food processing, gas separation, coatings and similar applications. One type of system used in cross-flow applications is a spiral wound filter element. A cylindrical spiral wound filter element may be placed within a housing. Seals may be placed within the housing to force unfiltered feed fluid flowing into the housing to pass through the spiral wound filter element. The spiral wound filter element has a permeate outlet tube that collects permeate that has passed through the filter membrane(s). Concentrated feed fluid may exit the housing from the opposite end from the feed flow inlet. According to this design, unfiltered feed fluid is introduced to a thin cross-section of each filter membrane. The end of a spiral would filter element near the unfiltered feed flow inlet will be referred to as the feed inlet end and the opposite end of the filter element will be referred to as the concentrate outlet end.

In a cylindrical spiral wound filter, the filter membrane is usually cast as a flat sheet on a backing material, which is typically a non-woven material. The filter membrane (including backing material) may be folded around a feed spacer material to form an envelope so that the backing material forms the outer surface of the envelope. The feed spacer material is usually a polypropylene web, such as that available from Naltex, Inc. of Austin, Tex. The backing material may then be adhered to a fabric sheet, such as Tricot, adong a “glue line”. The glue prevents unfiltered feed fluid from entering the fabric sheet (carrying the permeate) directly through the cross-section of the Tricot or the cross-section of the backing material. A typical spiral wound filter can have several layers of Tricot with a corresponding number of filter membrane envelopes therebetween. When the layers of Tricot and envelopes are wrapped around a permeate outlet tube, the Tricot layers act to transport permeate to the permeate outlet tube and the feed spacer material serves to transport unfiltered feed fluid and concentrate along the desired flow path. The ends of the filter element may then be trimmed.

The unfiltered feed fluid entering a filter membrane through its cross-sectional area may become trapped within the filter membrane or may work its way into the permeate side of the filter element (i.e., through the backing material into the fabric material transporting the permeate to the permeate outlet tube). The cross-sectional areas of the filter membrane may be exposed to the unfiltered feed fluid at the feed inlet end or concentrate outlet end of the filter element or, in some cases, at cracks in the filter membrane that may develop near the crease in a filter membrane envelope. Where the trapped unfiltered feed fluid is a liquid containing dissolved gases, the dissolved gases may come out of solution and expand when a pressure drop occurs (e.g., at the end of a filtration cycle) and cause blisters or de-lamination in the filter element. These blisters generally appear on the membrane over the “glue line” at either end of the filter element. As the filtration process continues, more unfiltered feed fluid is fed to the blister, causing further separation of the membrane from the backing until the blister breaks and creates a bypass path through which unfiltered feed fluid may enter the permeate outlet.

Trapped unfiltered feed fluid may also act as a source of permeate fluid contamination. For example, in some applications, such as whey processing in the dairy industry, trapped unfiltered feed fluid and solids may breed bacterial contaminants. Because the blisters are not in the normal flow path, they cannot be easily sanitized by forcing cleaning agents through the filtration system. Therefore, there is a need to prevent lateral flow of unfiltered feed fluid into a filter membrane to avoid contamination of permeate flow. Moreover, it is important to prevent lateral flow to avoid trapping of unfiltered feed fluid in the filter- membrane, which may lead to blistering and de-lamination of the filter element.

### BRIEF DESCRIPTION OF THE DRAWINGS

FIG. 1 depicts a dual-leaf spiral wound filter element that may be modified according to an embodiment of the present invention; and

FIG. 2 illustrates a cross-section of a filter element according to an embodiment of the present invention.

### DETAILED DESCRIPTION

Embodiments of the present invention are directed to filter elements that have been treated to prevent the entry of unfiltered feed fluid through a cross-sectional area of the filter element rather than through the lateral surface of the filter element. Pores in a portion of the filter element near a feed inlet end and/or concentrate outlet end may be filled with a polymer to prevent the flow of unfiltered feed fluid through the cross-section of the filter element. Although the following description focuses on embodiments of the invention related to spiral would filter elements, the present invention may also be applied to other types of filter elements in which it is desirable to block an undesired flow path through a filter membrane.

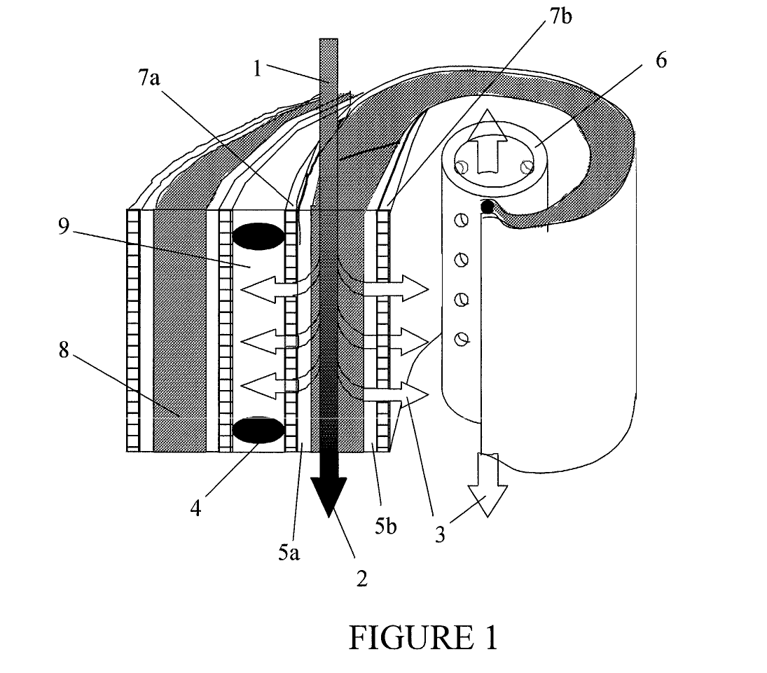

FIG. 1 illustrates a dual-leaf spiral wound filter element that may be treated according to embodiments of the present invention to prevent blistering, de-lamination and lateral feed flow. The dual-leaf filter element is shown unwound and each leaf is shown in cross-section for clarity. The arrows shown in FIG. 1 indicate the desired fluid flow paths if the filter elements functions as intended. The unfiltered feed flow 1 may enter the filter element from one end of the filter element along the desired flow path shown. As the unfiltered feed fluid passes across the surfaces of the filter membranes, permeate 3 may separate from the unfiltered feed flow 1 and pass through the filtration surface to openings in a permeate outlet tube 6. Where the filter membrane is formed into an envelope(s), the unfiltered feed fluid and concentrate may be transported by a feed spacer material, such as a polypropylene web, placed in the middle of the envelope. The permeate 3 may exit the filter element though the permeate outlet tube 6 around which envelopes incorporating the filter membrane (5a, 5b) and backing material (7a, 7b) may be wrapped. For outlying filter membrane envelopes, the permeate may be transported to the permeate outlet tube 6 by the fabric sheet 9 to which the backing material (7a, 7b) of the filter membrane (5a, 5b) is adhered. The remaining concentrated feed flow 2 may exit from the opposite end of the filter element. The increasing concentration of the feed fluid in the unfiltered feed flow 1 as it passes through the filter element is indicated by the change in color of the associated arrow in FIG. 1.

The unfiltered feed flow 1 may pass through the interior of an envelope, which may be a feed spacer material 8 such as a polypropylene web. The envelope may be created by folding a composite sheet of filter membrane (5a, 5b) and backing material (7a, 7b) around the feed spacer material 8. Adhesive 4 may be placed at the interface(s), between the backing material (7a, 7b) and the fabric sheet 9. The adhesive 4 may be, for example, a polyurethane or an epoxy. The line along which the adhesive 4 is applied is known as a “glue line.” The glue line will generally run along the portions of the fabric sheet 9 and backing material (7a, 7b) near the feed inlet and concentrate outlet ends of the filter element.

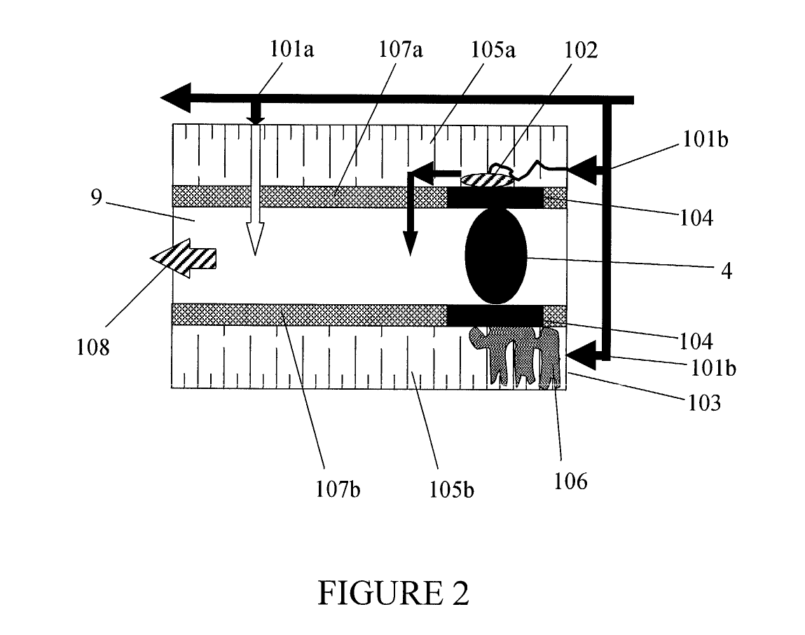

FIG. 2 shows the portion of the filter element of FIG. 1 that lies between two filtration envelopes. The upper filter membrane 102a is not treated according to an embodiment of the present invention and is shown to further illustrate the lateral flow mechanism to which blistering and de-lamination can be attributed. The lower filter membrane 102b has been treated according to an embodiment of the invention to prevent lateral flow of unfiltered fluid flow. The desired flow path 101a is substantially parallel to the surface plane of the filter membrane. Part of the unfiltered feed flow travelling along the desired flow path 101a travels through the upper filter membrane 105a and through the fabric sheet 107a to which the filter membrane 105a is adhered.

However, some of the unfiltered feed flow may also travel along the lateral flow path a 101b and enter the filter membrane 105a through its cross-sectional surface. The cross-sectional surface of the filter membrane 105a may be exposed to unfiltered feed fluid at either of the ends of the filter element or at cracks in the filter element, e.g., those that tend to form near the crease in an envelope. In and of itself, lateral flow of unfiltered feed fluid is problematic because unfiltered feed fluid travelling along the lateral flow path 101b may avoid filtration and contaminate the permeate flow being transported by the fabric sheet 9 (as indicated by the hatching of arrow 108 in FIG. 2). Another problem arises insofar as unfiltered feed flow travelling through the filter membrane 105a along the lateral flow path 101b may become trapped in the filter membrane 105a. The trapped unfiltered feed fluid may be subject to greatly increased pressures. If the trapped unfiltered feed fluid contains dissolved gases, these gases may come out of solution when the increased pressure fluctuates or is released (e.g., at the end of a filtration cycle). The escaping gases may push the filter membrane away from the fabric sheet to which it is adhered, forming a blister 102. The blister 102 will generally form in the portion of the filter membrane 105a above the glue line 104, since the unfiltered feed fluid cannot easily pass through a portion of the fabric sheet 107a that has been penetrated by the adhesive 4. As more unfiltered feed fluid enters the blister 102 along the later flow path 101b, the blister 102 may expand and burst. When the blister 102 bursts, the unfiltered feed fluid may bypass the filter membrane 105a almost altogether.

Filter membrane 105b has been treated according to method embodiments of the present invention. The filter membrane 105b may have a cross-sectional face 103 at which the lateral flow path 101b of unfiltered feed flow would begin. In embodiments of the present invention, the pores within the portion of the filter membrane 105b near this cross-sectional face 103 may be sealed to block the inlet of unfiltered feed fluid along the lateral flow path 101b. As shown in FIG. 2, these pores in the filter membrane 105b may be sealed by filling them with a suitable substance 106, such as a polymer. The substance 106 may be chosen for its ability to wet the filter membrane 105b (i.e., permeate the filter membrane 105b so as to fill the pores), its ability to be held in place inside the pores, and other factors that may be application-specific. For example, in food processing applications, it may be important to choose a polymer that will not contaminate the permeate or unfiltered feed flow and that will not foster the growth of bacterial contaminants. The ability of the substance to wet the filter membrane will depend upon the size of the pores in the filter membrane 105b and the viscosity of the substance, among other factors. Therefore, it may be desirable to select a low viscosity polymer, for example, as the pore-filling substance.

In embodiments of the invention, the pores may be filled with an adhesive, such as a low viscosity polyurethane glue (e.g., KALEX 25302A or 25302B available from Element is Specialties Performance Polymers of Belleville, N.J.). The adhesive may be applied to the cross-sectional face 103 (e.g., by painting or spraying the adhesive onto the surface) and allowed to dry to create a fluid-tight seal. Depending upon the type of adhesive used, the adhesive may need to be cured for a period of time to create the desired seal.

In alternative embodiments of the invention, the pores may be filled with a polymer solution and, once the solution has been absorbed into the pores of the filter membrane 105b, the solution may be cured to create a liquid-tight seal. For example-, the end of the filter membrane 105b near the cross-sectional face 103 may be soaked in or flushed with an aqueous solution that is 20% (by weight) hydroxy propyl acrylate (BPA) and 0.1% (by weight) triethylene glycol diacetate (TEGDA). One milliliter (1 mL) of the solution may be sufficient to soak or flush a 14 cm² area of the filter membrane 105b. The portion of the filter membrane 105b having the filled pores may then be cured by exposure to an ultraviolet (UV) light source or heat, rinsed and dried to create a liquid-tight seal. Alternatively, the filter membrane may be soaked in the solution and heated in an oven at a temperature sufficient to initiate the polymerization of the solution in the pores. The amount of time for which the filter membrane is exposed to UV light or heat may depend upon the intensity of the UV source or the heating temperature. Reaction initiators may be used to initiate thermal reactions, or to reduce the amount of exposure time or minimize the UV source intensity required, to cure the in-pore polymer.

During the curing process, it may be desirable to minimize the exposure of the pore-filling substance to oxygen. In embodiments of the invention, this may be accomplished by laminating the pore-filled portion of the filter membrane 105b between two sheets of polyethylene (approximately 2 mm in thickness) before exposing the portion to ultraviolet radiation. Alternatively, oxygen exposure may be minimized by performing the pore-filling and curing processed in an oxygen-free environment, such as a nitrogen-filled chamber.

In embodiments of the invention, the substance 106 may be applied to the cross-sectional face 103 of the filter membrane 105b by dipping the constructed filter element in the adhesive. However, in embodiments in which the substance 106 is applied to the end of a constructed filter element, it may be necessary to clear the feed channels of the substance 106, before the filter element can be used. This may be accomplished by sealing both ends of the filter element and blowing air or water through the filter element feed channels under pressure.

In embodiments of the invention in which pores are sealed by filling with a substance, it is desirable that the pores be relatively empty (“dry”) before the filling process begins, because otherwise the substance previously filling the pores (e.g., water) will need to be displaced for the new filling substance (e.g., a low-viscosity polymer) to be absorbed. Accordingly, in embodiments of the invention, wet membranes may be treated with surfactants, such as, glycerin or polyvinylpyrollidone, or other chemicals to empty the pores before applying the new pore-filling substance. These surfactants or other chemicals may be chosen so as to impart or preserve other filtration qualities of the membrane, such as, hydrophilicity. Alternatively, where the pores are previously filled by a volatile liquid (e.g., water), the pores may be emptied by exposure to heat. In other embodiments, it may be desirable to empty the pores by applying pressure to the surface of the membrane, so as to “squeeze” out the substance previously filling the pores.

In other embodiments of the invention, the pores of the filter membrane 105b may be sealed by heating the filter membrane and/or exposing it to pressure sufficient to “crush” the pores. In embodiments using heat to seal the pores, the temperature to which the filter membrane is heated may be sufficient to melt the filter membrane material and bond it to the backing material. Heat may be applied to the desired portion of the filter membrane using a thermal impulse sealer. Where pressure is used to seal the pores, the portions of the membrane web to be sealed (e.g., the edges near the ends of the filter element) may be passed between sets of rollers before the filter element is assembled.

While some of the embodiments of the present invention discussed above have focused on the sealing of surfaces at an end of the filter membrane 105b or filter element, it will be readily understood by those of ordinary skill in the art that other surfaces may be sealed according to this invention in much the same way. For example, cracks may appear in a portion of the filter membrane 105b near the crease in an envelope of filter membrane material or near the permeate outlet tube. Such cracks may also be sealed by, for example, filling them with a substance (such as, a polymer), applying pressure to compact the pores, or locally heating the membrane to cause the portion of the membrane containing the pores to melt.

While the description above refers to particular embodiments of the present invention, it should be readily apparent to people of ordinary skill in the art that a number of modifications may be made without departing from the spirit thereof. For example, although the description above focuses on an embodiment of the invention in the context of spiral wound filter elements, it will be understood by a person of ordinary skill in the art that the products and processes of the present invention can be used with other types of filter elements in which an undesired flow path must be blocked. The presently disclosed embodiments are, therefore, to be considered in all respects as illustrative and not restrictive. The accompanying claims are intended to cover such modifications as would fall within the true spirit and scope of the invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. A porous filter membrane for separating a permeate from an unfiltered feed fluid, the filter membrane comprising:
a permeate outlet surface;
a first surface exposed to said unfiltered feed fluid, said filter membrane having a desired flow path for filtration beginning at said first surface and ending at said permeate outlet surface;
a second surface exposed to said unfiltered feed fluid, wherein a pore proximate said second surface is sealed to prevent entry of said unfiltered feed fluid into said filter membrane through said second surface.

2. The filter membrane according to claim 1, wherein said sealed pore is fixedly filled with a substance.

3. The filter membrane according to claim 2, wherein said substance is a polymer.

4. The filter membrane according to claim 3, wherein said polymer is a low viscosity polymer.

5. The filter membrane according to claim 3, wherein said polymer is cured.

6. The filter membrane according to claim 5, wherein said polymer is cured by exposure to ultraviolet radiation.

7. The filter membrane according to claim 5, wherein said polymer is cured by exposure to heat.

8. The filter membrane according to claim 1, wherein said sealed pore is sealed by applying pressure to a portion of said filter membrane proximate said second surface.

9. The filter membrane according to claim 1, wherein said sealed pore is sealed by applying heat to a portion of said filter membrane proximate said second surface.

10. The filter membrane according to claim 9, wherein sufficient heat is applied to said portion of said filter membrane to cause said portion of said filter membrane to melt.

11. The filter membrane according to claim 1, wherein said second surface is exposed to said unfiltered feed fluid along a crack in said filter membrane.

12. The filter membrane according to claim 11, wherein filter membrane is formed into an envelope, and further wherein said crack in said filter membrane is proximate a crease in said envelope.

13. The filter membrane according to claim 11, wherein said filter membrane is wound around a permeate outlet tube, and further wherein said crack is proximate said permeate outlet tube.

14. A porous filter membrane for separating a permeate from an unfiltered feed fluid, the filter membrane comprising:
a permeate outlet surface;
a lateral filtration surface, said unfiltered feed fluid flowing across said lateral filtration surface, wherein said filter membrane has a desired flow path for filtration beginning at said lateral filtration surface and ending at said permeate outlet surface;
a cross-sectional surface exposed to said unfiltered feed fluid, wherein a plurality of pores proximate said second surface is sealed to prevent entry of said unfiltered feed fluid into said filter membrane through said cross-sectional surface.

15. The filter membrane according to claim 14, wherein said sealed plurality of pores is fixedly filled with a substance.

16. The filter membrane according to claim 15, wherein said substance is a polymer.

17. The filter membrane according to claim 16, wherein said polymer is a low viscosity polymer.

18. The filter membrane according to claim 16, wherein said polymer is cured.

19. The filter membrane according to claim 18, wherein said polymer is cured by exposure to ultraviolet radiation.

20. The filter membrane according to claim 18, wherein said polymer is cured by exposure to heat.

21. The filter membrane according to claim 14, wherein said sealed plurality of pores is sealed by applying pressure to a portion of said filter membrane proximate said second surface.

22. The filter membrane according to claim 14, wherein said sealed plurality of pores is sealed by applying heat to a portion of said filter membrane proximate said second surface.

23. The filter membrane according to claim 22, wherein sufficient heat is applied to said portion of said filter membrane to cause said portion of said filter membrane to melt.

24. A filter membrane for separating a permeate from an unfiltered feed fluid, the filter membrane comprising:
a permeate outlet surface through which said permeate exits the filter membrane;
a filtration surface exposed to said unfiltered feed fluid;
a plurality of open pores between said permeate outlet surface and said filtration surface, said plurality of open pores defining a desired flow path for said permeate to travel through said filter membrane;
a second surface exposed to said unfiltered feed fluid; and
a plurality of sealed pores between said permeate outlet surface and said second surface, said plurality of sealed pores preventing said unfiltered feed fluid from entering said filter membrane through said second surface.

25. The filter membrane according to claim 24, wherein said plurality of sealed pores is fixedly filled with a substance.

26. The filter membrane according to claim 25, wherein said substance is a polymer.

27. The filter membrane according to claim 26, wherein said polymer is a low viscosity polymer.

28. The filter membrane according to claim 26, wherein said polymer is cured.

29. The filter membrane according to claim 28, wherein said polymer is cured by exposure to ultraviolet radiation.

30. The filter membrane according to claim 28, wherein said polymer is cured by exposure to heat.

31. The filter membrane according to claim 24, wherein said plurality of sealed pores is sealed by applying pressure to a portion of said filter membrane proximate said second surface.

32. The filter membrane according to claim 24, wherein said sealed pore is sealed by applying heat to a portion of said filter membrane proximate said second surface.

33. The filter membrane according to claim 22, wherein sufficient heat is applied to said portion of said filter membrane to cause said portion of said filter membrane to melt.

34. The filter membrane according to claim 24, wherein said second surface is exposed to said unfiltered feed fluid along a crack in said filter membrane.

35. The filter membrane according to claim 34, wherein filter membrane is formed into an envelope, and further wherein said crack in said filter membrane is proximate a crease in said envelope.

36. The filter membrane according to claim 34, wherein said filter membrane is wound around a permeate outlet tube, and further wherein said crack is proximate said permeate outlet tube.

37. A filter element useful for separating a permeate from the unfiltered feed fluid, said filter element comprising:
a backing material layer having a first surface and a second surface;
a permeate transport layer to which the second surface of said backing material layer is adhered;
a filter membrane cast on said first surface of said backing material layer, said filter membrane having:
a filtration surface;
a cross-sectional surface; and
a plurality of sealed pores proximate said cross-sectional surface blocking an undesired flow path between said cross-sectional surface and said backing material layer.

38. The filter element according to claim 37, wherein the filter element is a spiral wound filter element.

39. The filter element according to claim 37, wherein said backing material layer is adhered to said permeate transport layer along a glue line, and further wherein said plurality of sealed pores is located proximate said glue line.

40. The filter element according to claim 37, wherein said plurality of sealed pores is filled with a polymer.

41. The filter element according to claim 37, wherein a portion of said filter membrane proximate said second surface is compressed under pressure to cause said plurality of sealed pores to be sealed.

42. The filter element according to claim 37, wherein a portion of said filter membrane is exposed to heat to seal said plurality of sealed pores.

43. A method of manufacturing a filter element useful for separating a permeate from an unfiltered feed fluid, said method comprising:
casting a porous filter membrane on a backing material, said filter membrane having a filtration surface and a second surface such that permeate flows through said filter membrane from said filtration surface to said backing material along a desired flow path; and
sealing a plurality of pores between said second surface and said backing material to prevent said unfiltered feed fluid from entering said filter membrane through said second surface.

44. The method of manufacturing a filter element according to claim 43, wherein sealing said plurality of pores includes filling said plurality of pores with a substance.

45. The method of manufacturing a filter element according to claim 44, wherein filling said plurality of pores includes soaking a portion of said filter element proximate the second surface in a solution containing the substance.

46. The method of manufacturing a filter element according to claim 44, wherein said substance is a polymer.

47. The method of manufacturing a filter element according to claim 44, wherein said substance is a low viscosity polymer.

48. The method of manufacturing a filter element according to claim 44, wherein sealing said plurality of pores further includes curing said substance after said plurality of pores has been filled with said substance.

49. The method of manufacturing a filter element according to claim 48, wherein curing said substance includes exposing said plurality of pores to one of ultraviolet radiation and heat.

50. The method of manufacturing a filter element according to claim 43, wherein sealing said plurality of pores includes applying pressure to a portion of said filter membrane to compress said plurality of pores.

51. The method of manufacturing a filter element according to claim 43, wherein sealing said plurality of pores includes applying sufficient heat to a portion of said filter element to cause said portion of said filter element to melt.

52. The method of manufacturing a filter element according to claim 43, wherein said second surface is a cross-sectional surface of said filter membrane.

53. The method of manufacturing a filter element according to claim 43, wherein said second surface is exposed to said unfiltered feed fluid along a crack in said filter membrane.

54. The method of manufacturing a filter element according to claim 53, said method further including forming said filter membrane into an envelope having a crease, and further wherein said crack in said filter membrane is proximate said crease.

55. The method of manufacturing a filter element according to claim 53, said method further including winding said filter membrane around a permeate outlet tube, and further wherein said crack is proximate said permeate outlet tube.
